(19) United States
(12) Patent Application Publication
(10) Pub. No.: US 2005/0038726 A1
(43) Pub. Date: Feb. 17, 2005

(54) On-demand defined securitization methods and systems

(75) Inventors: David Bela Salomon, Beverly Hills, CA (US); Vincent Viola, Chatham, NJ (US)

Correspondence Address: FOLEY & LARDNER, 2029 CENTURY PARK EAST, SUITE 3500, LOS ANGELES, CA, 90067, US

(73) Assignee: EWT, LLC

(21) Appl. No.: 10/911,308

(22) Filed: Aug. 4, 2004

Related U.S. Application Data
(60) Provisional application No. 60/494,361, filed on Aug. 12, 2003.

(51) Int. Cl. G06F 17/60

(52) U.S. Cl. 705/36

(57) ABSTRACT

Methods for creating and providing securities for investors and other market-interested parties involve creating investment entities with associated assets and corresponding securities, such as shares in the investment entities, in a time effective manner and in response to an investor's demand. The assets of the investment entity may be formed as an exchange traded fund (“ETF”) and may include shares of stock, bonds, options, convertibles, currencies, warrants, futures, commodities, real estate, other hard or soft assets and/or other items of value. An investment entity may be formed in any suitable legal structure, such as, but not limited to, a corporation, organization, business trusts, partnerships or the like, that is capable of holding the assets of the investment entity. An investment entity may hold one or more portfolios of common stocks, bonds, or other assets. In some example embodiments of the present invention, the (or at least one) portfolio in the investment entity's assets may be designed to track one or more indices by investing in at least a representative, e.g., proportional, sample of securities that are included in the particular indices to be tracked.

### RELATED APPLICATION

The present invention relates to U.S. Provisional Application Ser. No. 60/494,361, filed Aug. 12, 2003, titled “On-Demand Defined Securitization,” which is incorporated herein by reference in its entirety and which forms a priority filing date for the present invention.

### BACKGROUND OF THE INVENTION

The present invention relates to methods for creating and providing securities for investors and other market-interested parties. Particularly, embodiments of the present invention relate to methods and systems for creating investment entities with associated assets and corresponding securities, such as shares in the investment entities, in a time effective manner and in response to an investor's demand. The asssets of the invenstment entity may be formed as, for example, an exchange traded fund (“ETF”) and may include shares of stock, bonds, options, convertibles, currencies, warrants, futures, commodities, real estate, other hard or soft assets and/or other items of value.

An investment entity, according to embodiments of the present invention, may be formed in any suitable legal structure, such as, but not limited to, a corporation, organization, business trusts, partnerships, etc., that is capable of holding the assets of the investment entity. An investment entity may hold, for example, as one or more portfolios of common stocks, bonds, or other assets. In some example embodiments of the present invention, the (or at least one) portfolio in the investment entity's assets may be designed to track one or more indices by investing in at least a representative, e.g., proportional, sample of securities that are included in the particular indices to be tracked.

Examples of prior ETFs include Stadard & Poor's Depository Receipts (SPDRs), which may be ETFs that invest in all of the stocks contained in the S&P 500 Composite Stock Price Index, TLT Bonds or the like. Unlike shares issued by other open-end companies or Unit Investment Trusts, ETF shares have not historically been sold individually to investors. More often, institutional investors have purchased creation units, e.g., large blocks of shares, that mirror the ETF's portfolio. The investors may then sell all of the shares, or smaller blocks of the shares, in the ETF on the secondary market.

On the secondary market, ETF shares have been traded in a fashion similar to that of common stock. This provides a number of advantages over shares in other types of investment companies, such as mutual funds, including flexibility with respect to trading, tax efficiency, continuous price changes and all-day tracking and trading, etc. As noted above, however, the contents of an ETF portfolio have been limited to securities of companies included in the original issue, for example in a particular index. This can be undesirably inflexible from a particular investors' perspective with regard to using the selected investment objective of the ETF and the timeliness at which the ETF is created relative to the investor's investment/divestment timing needs.

Moreover, securities such as ETFs have traditionally been created, and their related securities registered, on a case-by-case basis through use of processes which require the investment of relatively large amounts of time and effort by parties seeking to create the ETF. For example, typically, the ETF must meet government, regulatory or other industry or policy requirements, a trust for assets is established, sourcing and underwriting is established, a distributor is selected , terms relevant to the ETF are created, the ETF is listed, etc

Accordingly, there is a need for investment entities and procedures for forming investment entities that can rapidly provide investors with custom-defined ETF securities or securities that have the advantages of ETF shares, i.e., flexible trading, tax efficiency, all day tracking and trading, etc., and which are also responsive to the objectives of the investment entity, e.g., with respect to the contents of the assets contained in the security portfolio; for methods of creating such entities and funds; and for creating and marketing the shares such entities could provide. There is a need for a process for creating such securities on the demand of investors, hedgers or other market interested parties in an efficient and rapid manner, in order to timely and effectively respond to the needs of the investors and the marketplace.

### SUMMARY OF THE DISCLOSURE

Embodiments of the invention provide investment entities and procdures for creating investment entities with vehicles to rapidly provide custom-defined securities that are ETF shares or have the advantages of ETF shares, i.e., flexible trading, tax efficiency, all day tracking and trading, etc., and which are also responsive to the objectives of the investors or other interested parties with respect to the contents of the assets contained in the security portfolio; and methods for creating and marketing shares provided by such entities. Embodiments of the invention further provide processes for creating securities at the demand of investors, in an efficient and rapid manner, in order to timely and effectively respond to the needs of the investors and the marketplace. Such processes may be referred to as on-demand defined securitization.

In one aspect, the present invention provides methods, implemented by computer or otherwise, for creating investment entities, such as ETFs, at the demand of and as defined by investors. When created, such investment entities hold baskets, or portfolios, of assets, e.g., securities, as defined and at the demand of market makers or other investors. This aspect allows, for example, investors to create securities in investment entities that hold portfolios of securities defined by the investors, and/or satisfies the requirement of best execution that are associated with trading the bundle of securities separately. This aspect further allows, for example, investors to create custom indices based on the defined basket of assets. Although embodiments of the present invention may be described by way of example in relation to particular investment entities, securities, and/or particular parties, it is understood that the present invention may be applied with regard to various entities and assets, and is thus not limited thereto.

According to the first aspect, processes and systems enable investors to define or provide the specification for the investment entity, including for example details regarding the contents of the investment entity's portfolio(s), the size of creation/redemption units, timing, quantities of securities, and/or the identity of the trustee or other person or entity responsible for managing the company, as well as other features consistent with the objects, systems, and processes disclosed herein. Investors are thereby enabled to create securities in investment entities such as ETFs that have portfolios whose contents, creation/redemption details, trustee, etc., are defined by the investors. For example, an institutional investor may define the contents of the portfolio based on 50,000 shares of various companies' stocks. The stocks or other assets may comprise a distinct grouping, e.g., of automotive stock in which case the investor wishes to create an index fund.

According to another aspect of embodiments of the invention, investment entities to be created would potentially be pre-authorized by regulatory or other agencies to create such funds, so as to minimize the time elapsed between definition of the investment objective and securitization of the desired assets, as for example through the use of fast track, shelf registrations or other pre-authorization procedures. Fast track privileges have been granted by the Commodities Future Trading Commission (CFTC) to allow certain future exchanges to expeditiously list new commodity contracts.

An investment entity may be created to hold a single portfolio as defined by a single investor (or group of investors), or a plurality of portfolios defined by multiple investors or investor groups, so that a single investment entity (e.g., an umbrella entity) comprising a plurality of sub-entities, for example, individual companies or sub-companies dedicated to the creation and selling of individual ETF securities, may be created. For instance, a single trust may be created with a plurality of sub-trusts, each of which is created to hold a single portfolio. The sub-trust may then create an investment entity, such as an ETF, that holds the sub-trust portfolio as defined by the investor.

As will occur to those familiar with the applicable arts, upon reviewing this specification, a great many configurations of support devices according to the invention are possible and will serve to accomplish the purposes described herein.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 is a block diagram showing entities involved in a securitization system according to an embodiment of the present invention.

FIG. 2 is a block diagram showing an Internet (or other network) related embodiment of a securitization system and entitites involved with the system.

FIG. 3 is a flow diagram of a process for on-demand defined securitization according to one embodiment of the invention.

FIG. 4 is a block diagram showing relationships between various entities involved in an on-demand defined securitization according to a preferred embodiment of the invention.

FIG. 5 is a flow diagram of a securitization process with pre-approvals, according to an embodiment of the present invention.

### DETAILED DESCRIPTION OF THE PREFERRED EMBODIMENTS

The following detailed description is of the best presently contemplated mode of implementing embodiments of the invention. This description is not to be taken in a limiting sense, but is made merely for the purpose of illustrating general principles of embodiments of the invention. The scope of the invention is best defined by the appended claims.

The present invention relates to methods and systems for creating investment entities and corresponding securities such as shares in the investment entities, on demand and according to investors' defined specifications. Further embodiments relate to such methods and systems which provide on-demand, investor-defined securitization in an expedited manner, based on pre-established parameters, guidelines or limitations arranged with one or more government or regulatory entities, trustee entitees and exchange or listing entities. On-demand, investor-defined securitization can provide investors with rapid, custom-defined securities that are designed to better address the particular needs or requests of each investor.

Embodiments of the present invention may be employed by an entity, refered to herein an on-demand facilitator (ODF), conducting a business of or relating to on-demand securitization for investor clients. An ODF may receive a communication (telephone call, email, postal mail, delivery or the like) from an investor, requesting a security that is backed or based on certain assets specified by the investor. Based on the investor's request, the ODF may create and list a security based on the investor's defined specifications. An ODF may be a trading company, a trust company, hedge fund, mutual fund, investor group, stock exchange, or other suitable entity capable of performing the ODF functions described herein for investor clients.

In some example embodiments, the ODF may conduct an income-generating business by providing ODF services for compensation, to entities who wish to cause an ETF to be formed, as described herein. For example, a suitable compensation arrangement may be created to meet legal government, regulatory and other industry or policy requirements, whereby the ODF may be compensated with a fixed fee paid by the party interested in forming the investment entity, a fee based on a percentage or other relationship to the assets purchased or sold upon creation or formation of the investment entity and/or during a defined period or the entire duration of the investment entities existance, a fixed or variable (based on asset value) paid periodically or at pre-defined times or upon occurances of predefined events, combinations thereof. The ODF fees may be paid directly by a party interested in forming an investment entity and/or from assets of the investment entity. In further embodiments, fees for the ODF, trustee and others involved in creating and operating the investment entity may be derived from the assets of the investment entity, for example, by liquidating small portions of those assets, as needed, to pay appropriate expenses and fees.

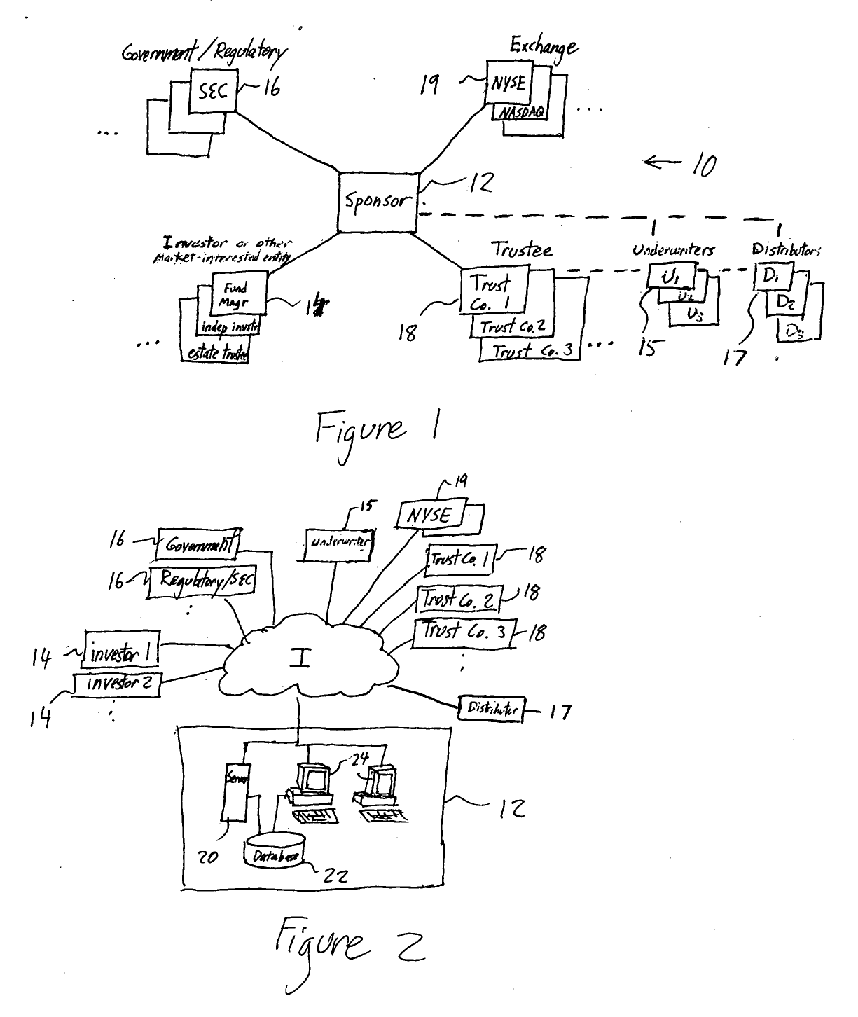

FIG. 1 is a block diagram of a business system 10, showing various entities, including an ODF 12, that may be involved in systems or processes according to embodiments of the present invention. In FIG. 1, the ODF 12 is arranged for communication with one or more investor clients 14 interested in sponsoring investment entities. Depending upon the embodiment, the investor client 14 may comprise an individual investor, a fund manager, an investment group, a hedger, or other market interested entity. For purposes of simplifying the present description, the term “investor” is used to refer to any one of those enties. As described in more detail in the example processes below, the ODF 12 may receive a request from an investor 14 to create a proposed investment entity, including information regarding an asset set to be included in a portfolio to be held by the proposed investment entity.

The term “investment entity” is used herein to refer to any suitable legal structure, such as, but not limited to, a corporation, organization, business trusts, partnerships, etc., that is capable of holding an asset portfolio, such as a basket of shares as defined by an investor, for which securities representing an investment in the company or entity may issue. An investment entity may hold, for example, as one or more portfolios of common stocks, bonds, or other assets. An investment entity's portfolio may comprise a fund, such as an ETF. In some example embodiments of the present invention, the (or at least one) portfolio in the investment entity assets may be designed to track one or more indices. For example, an investment entity holding an index-tracking portfolio may invest in at least a representative, e.g., proportional, sample of securities that are included in the particular index to be tracked. In further example embodiments, tracking of the index over a period of time may involve further investing and divesting of assets of a portfolio of an investment entity over a period of time. Such further investments or divestments may be carried out by the ODF or a manager or other suitable agent employed or contracted by the ODF.

If the ODF 12 determines that the information regarding an asset set received from an investor 14 meets pre-defined parameters, guidelines or limitations, the ODF may obtain suitable regulatory or government approvals for forming a security for an investment entity backed by the asset set. Regulatory or government approvals may be required or otherwise desired, depending upon the type of assets included in the asset set and/or the manner in which the investment entity security is to be traded. For example, in certain embodiments, an approval of the Securities and Exchange Commission (SEC) may be obtained. Accordingly, FIG. 1 shows that the ODF 12 is also arranged for communication with one or more suitable regulatory and/or governmental entities 16 (such as, but not limited to, the SEC) for obtaining approvals, as needed.

In preferred embodiments, some or all necessary regulatory or government approvals are obtained in advance, based on the pre-defined parameters, guidelines or limitations. For example, through a pre-established arrangement between the ODF 12 and the regulatory or governmental entity 16, one or more parameters, guidelines and/or limitations may be determined and agreed upon in advance, such that any later-defined asset set that meets the parameters, guidelines and/or limitations would receive automatic, fast track approval (or the ability to obtain post-approval processing, after listing) with no further action required. Alternatively, the pre-established arrangement may implement a procedure wherein any asset set that meets pre-set parameters, guidelines and/or limitations would be placed on a fast-track approval program, for expedited evaluation for approval by the government or regulatory entity 16.

By defining, in advance, parameters, guidelines and/or limitiations that are based on or exceed the requirements of the governmental or regulatory entity, an expedited procedure for obtaining necessary or desired approvals may be implemented. In preferred embodiments, the ODF 12 determines suitable parameters, guidelines and/or limitations to obtain government or regulatory approvals and assists the investor14 in determining whether the investor-defined asset set meets those parameters, guidelines and/or limitations. In further embodiments, the ODF 12 may assist the investor in modifying or defining an asset set and investment entity that meets those parameter, guidelines and/or limitations. Such parameters, guidelines or limitations may include, but are not limited to, specifying the types of assets (such as stocks traded on NYSE or other specified exchange or a list of available assets), a level of diversification, a minimum level of capitalization for each security or for defined groups of securities, risk parameters or the like.

FIG. 1 also shows that the ODF 12 is arranged for communication with one or more trustee entities 18, for creating a trust for holding the portfolio assets of the investment entity. In other embodiments, other suitable vehicles, other than a trust, may be employed for holding such assets. In certain preferred embodiments, the ODF may have a pre-arranged relationship with one or more trustees for handling trusts associated with investment entities that meet certain pre-defined parameters, guidelines or limitations.

For example, through a pre-established arrangement between the ODF 12 and the trustee entity 18, one or more parameters, guidelines and/or limitations may be determined and agreed upon in advance, such that any later-defined asset set and investment entity that meets the parameters, guidelines and/or limitations would receive automatic approval for the formation of a trust. In further embodiments, all or some of the documents employed by the trustee in connection with the formation of a trust may be pre-established and prepared in advance, but left incomplete with respect to defining the particular assets within the asset set of the investment entity portfolio. However, pursuant to the pre-established arrangement between the ODF 12 and the trustee 18, parameters, guidelines and/or limitations may be defined for the type of assests that may be included in the asset set of the investment entity portfolio to achieve an automatic approval or expedited evaluation or processing for approval by the trustee.

The ODF 12 in FIG. 1 is also arranged for communication with one or more securities exchanges (such as, but not limited to, the NYSE, NASDAQ, Chicago Stock Exchange, National Stock Exchange, Pacific Stock Exchange) or other securities listing entities 19. In this manner, securities, such as stocks, created on demand for the investment entity may be listed on an exchange by the ODF 12 or other suitable entity under the instructions of the ODF 12.

In certain preferred embodiments, the ODF may have a pre-arranged relationship with one or more exchanges for listing securities for investment entities that meet certain pre-defined parameters, guidelines or limitations. For example, through a pre-established arrangement between the ODF 12 and the exchange entity 19, one or more parameters, guidelines and/or limitations may be determined and agreed upon in advance, such that any later-defined investment entity that meets the parameters, guidelines and/or limitations would receive automatic approval for listing on the exchange or would receive an expedited evaluation or processing for approval by the exchange.

The ODF (or the trustee or the exchange) may have pre-established arrangement with one or more underwriters 15 and/or distributors 17, for providing underwriting and/or distributing functions or services, as may be needed or desired for the creation of an ETF, fund or other asset in a portfolio of an investment entity. For example, through a pre-established arrangement between the ODF 12 and an underwriter or distributor, one or more parameters, guidelines and/or limitations may be determined and agreed upon in advance, such that any later-defined investment entity portfolio that meets the parameters, guidelines and/or limitations would be underwritten or distributed by the underwriter or distributor, respectively.

Accordingly, systems and processes for on-demand securitization may be implemented by providing: (1) a mechanism for receiving requests from investors for securitization of asset sets defined by the investors; and (2) pre-established arrangements with one or more of the governmental or regulatory entities 16, trustee entitees 18 and exchange entities 19 based on pre-defined parameters, guidelines or limitiations. In addition, the ability to request and obtain securitization on-demand can be further enhanced, when employed in a computer network environment.

Thus, while certain communications between entities shown in FIG. 1 may be carried out through various suitable modes of communication, including, but not limited to computer network, telephone, facsimile, postal mail or delivery, preferred embodiments employ one or more computer network connections through the Internet or other suitable wide area network, intranet, extranet or the like, for providing some or each communication link in the system 10. For example, in the embodiment shown in FIG. 2, a ODF 12 may include one or more network servers 20 and/or other network connected computers 22 programmed or otherwise configured for providing certain functions described herein, including for providing one or more network sites (such as Internet websites, intranet or extranet sites) on a network (such as the Internet, an intranet or an extranet) accessable by many potential investor clients 14. Internet websites can provide user-friendly, readily accessable interfaces for investors to access the system 10 from all over the world and at any time or date, to submit information to request the creation of an investment entity or to access information about investment entities.

As shown in FIG. 2, the ODF 12 may include or operate with one or more databases 22 for storing information accessable to investor clients 14 on the website, as described below. The ODF 12 also may include one or more network computers 24 operated by secure, trained personel. In an example embodiment, the personel on the computers 24 may be provided with access to information received from potential investor clients 14 and may be trained to make certain determinations regarding whether or not an asset set or other investment entity information received from a potentional investor client 14 meets appropriate parameters, guidelines and limitations for regulatory or governmental approvals, trustee requirements, exchange listing requirements or the like. Alternatively, or in addition, such personell may provide assistance to investor clients to define an asset set, index, portfolio or other investment entity information that would meet the appropriate parameters and limitations.

In yet further embodiments, the server(s) 20 and/or computer(s) 24 may be programmed or otherwise configured to make determinations regarding whether or not an asset set or other investment entity information received from a potential investor client 14 meets appropriate parameters, guidelines and limitations. In such embodiments, the server(s) 20 and/or computer(s) 24 may be programmed or otherwise configured to provide the potential investor client with information, messages, warnings or the like, indicating discerpencies, if any, between the asset set or other investment entity information received from the investor and the parameters, guidelines and limitations.

The server(s) 20 and/or computer(s) 24 of the ODF 12 may be connected to the Internet or other network by any suitable network connetion hardware and software components and connections. Also as shown in FIG. 2, other entities included in embodiments of the system 10 may be connected for communication on the Internet or other network. Thus, for example, investors 14 may communicate through a network connection to access an ODF website and request the creation of an investment entity or access information about investment entities, as described above. An ODF, a trustee, an exchange, or other entity may communicate information regarding proposed or new investment entities or existing investment entities, including, but not limited to, prospectuses, general descriptions, performance evaluations, fee schedules or the like. Network communications may be accommodated in any suitable manner, including, but not limited to, email communications, links or postings on network sites or the like. Thus, for example, personell operating computers 24 may send email communications to personell operating computers for the entities 16, 18 and 19 to accomplish formation, regulatory approval, exchange listings and other ODF functions. In one example embodiment of an automated system, the server(s) 20 may be programmed to provide some or all of the communications to entities 16, 18 and 19, through pre-programmed or generated messages, based on information received from the investor 14. Also, an exchange entity 19 may perform a role of electronically announcing and exchanging information, for example, regarding listing of shares of the investment entity.

A system 10 as shown in FIG. 1 may be employed in an Internet environment, as shown in the embodiment of FIG. 2, or other communication environments, to provide a vehicle for investors to create investment entities on demand and to the investors specification. While the system example shown and described with respect to FIG. 1 includes an ODF 12 arranged in communication with one or more investor entities 14, in other embodiments, an investor 14 may be capable of performing the functions of the ODF 12 and may take on that role. In yet further embodiments, a trustee entity 18 or an exchange entity 19 may be capable of performing the functions of the ODF 12 and may take on the role of an ODF 12.

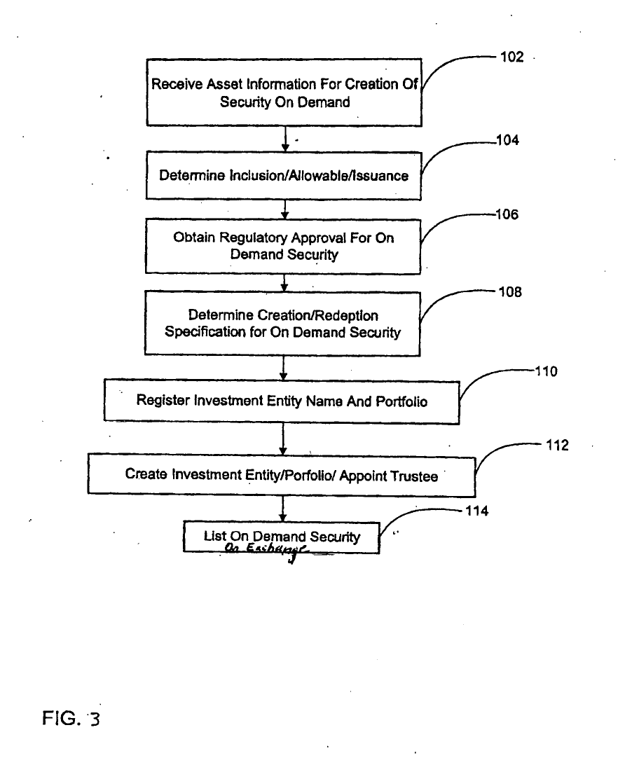

Referring to FIG. 3, in one embodiment of the present invention, a method for on-demand defined securitization begins at 102 with receiving from a source, such as an investor or other market-interested party, information regarding the securitization to be provided on demand, including information regarding a set of assets to be included in a portfolio of an investment entity. The information may be received from the investor through any suitable communication channel, including, but not limited to computer network, telephone, facsimile, postal mail or delivery. In preferred embodiments the information may be received through the Internet or other suitable network, for example, through a website provided for the investor's access to the system. The website may include a page or other location having one or more forms, fields or other defined areas for the investor to input securitization information. In further embodiments, the website may include a page or other location listing a plurality of investment entity options from which the investor may select, each option comprising at least one specific asset set, defined trustee, exchange, ODF, underwriter, distributor, and/or a defined set of parameters, guidelines and limitations for an approved asset set.

Further information regarding the investment entity to be created on demand may be received from the investor 14, including information regarding size of creation and/or redemption units, the total quantity of shares to be created, the identity of a trustee to manage the investment entity, timing requirements for the securitization, etc. The investor 14 therefore may be able to specify, for example, a date or time by which the securities are to be created, the composition of the portfolio of assets to be used to create the investment entity securities, the identity of the trustee or other individual or entity who will create and issue the securities, and/or the size of creation and for redemption units of the security. This on-demand feature provides the ability of an investor to define details regarding the investment entity, e.g., the ETF, including the contents of the initial creation portfolio, rather than a ODF or other entity. In some embodiments, an investor may be able to specify or select from options relating to private placement or restricted investment groups. For example, an investor (or the ODF) may specify criteria, requriments, or other qualifications necessary to purchase securities in the investment entity, such as, but not limited to, investor class, investment experience, tax status, net worth, citizenship, nationality or other factors.

Various types of assets or combination of assets may be included in the portfolio, including, but not limited to, securities, such as stocks, bonds, options, convertibles, currencies, warrants, futures, entertainment revenue, advertiseing minutes, commodities, etc., real property, intellectual property, personal property (chattels), etc. The investor may define the asset or assets that form the portfolio, but may refer to or be required to meet certain parameters, guidelines or limitations relating to the assets included in a portfolio. In Internet or other network embodiments as described above, such parameters, guidelines or limitiations may be posted or otherwise described on a location on the network site accessable to the investor and/or authorized personell.

At 102 information may be received from various entities or investors, including institutional as well as individual investors, depending upon embodiments of the invention. In one example embodiment, an investor may specify relevant information regarding the asset set, including identification of the asset or assets included in the asset set. In one example embodiment, an investor may be provided with a list or other format of multiple possible securities or other assets from which the investor may select to include in the asset set for the portfolio. For example, in Internet or other network embodiments as described above, an investor may be provided access to a list of optional securities or other assets at a suitable location on the ODF's network site. In other embodiments, lists of optional securities may be provided to investors in other suitable manners, including, but not limited to telephone, facsimile, postal mail or delivery. One or more lists (or other format) of assets that may be included in an asset set may be created by an ODF 12, trustee entity 18, exchange entity 19, distributor, underwriter or other suitable entity, as representing optional assets that would be acceptable to those entities and/or likely to result in approvals from appropriate governmental, regulatory or industry entities. In other embodiments, investors may select and identify securities or other assets for a portfolio, without reference to a pre-defined list. In yet further embodiments, software may be provided to the investor and/or the server(s) 20 or computer(s) 24 may be programmed to provide recommendations to design or modify portfolios to meet certain criteria, regulations, guidelines or the like. In yet further embodiments, such software or programming may base recommendations, at least in part, on maximizing or meeting a prescribed level of diversification, optimizing sale or purchase price, optimizing income, optimizing growth and/or avoiding overlaps and providing suitable differentiation relate to existing ETFs or other funds.

In one example, an investor may define an investment entity security for creating or tracking a new or established index by specifying information identifying stocks or other interests in various indexes or selected industries, providing, for example, a total amount of identified shares, the amount or allocation of the shares for each company included in the index, the company names, stock symbols, etc. Thus, an investor interested in certain sectors of the the automotive industry may, for example, create an index of stocks of companies that supply components to automobile manufacturers, or of stocks of companies that produce automobile tires, by specifying such information regarding a set of relevant stocks in the interested industry or sector.

An ODF may specify parameters or guidelines or impose limitations regarding the assets that may be included in the asset set of a proposed investment entity portfolio. For example, at 104 a determination is made as to whether or not the information received from the investor is allowable. The parameters, guidelines or limitation may limit, specify or otherwise relate to the type of asset or assets or a quantity of the asset or assets that may be included in an investment entity portfolio. For example, the ODF may impose restrictions that limit the asset set to listed securities or securities listed on one or more particular, identified exchanges. The ODF may also impose parameters, guidelines or limits regarding the size of the asset set, such as a minimum and/or maximum numbers of shares for the portfolio, diversification factors, minimum and/or maximum values for the portfolio e.g., at the creation of the portfolio, etc. The parameters, guidelines or limitations may be for compliance with or, in some embodiments, exceeding compliance criteria for regulatory approval, trustee requirements, exchange requirements or otherwise. In an example embodiment, the parameters, guidelines or limitations imposed by the ODF may be determined by the ODF, based on pre-established arrangements with at least one of government or regulatory entities, trustee entitees and exchange entitees, for expediting approval and listing procedures.

In one example embodiment, the ODF server(s) 20 or computer(s) 24 are configured or otherwise programmed to receive an electronic input comprising an investor's selection of assets to include in a proposed investment entity portfolio and/or other information regarding the proposed investment entity. Such information may be received from an investor, for example, through an Internet session in which the investor enters such information on the ODF's website, or by other suitable manners of communication, including, but not limited to telephone, email, fax, postal mail, delivery or the like. Once received, trained personel associated with the ODF may review information received from investors and compare the information to pre-defined parameters, guidelines or limitations, as described above. If the information received from an investor does not comply with some or all of the pre-defined parameters, guidelines or limitations, then the trained ODF personel may notify the investor of deficiciencies and, in some embodiments, may assist the investor in re-defining or modifying the information to comply with the pre-defined parameters, guidelines or limitations. In an Internet or other network embodiment as described above, the trained sponser personel may communicate with investors over the Internet or other network to provide such notices and/or assistance, through a ODF computer 24 connected for communication on the network.

In further embodiments, the ODF server(s) 20 or computer(s) 24 may be configured or otherwise programmed to perform routines, such as rule-based routines for comparing or otherwise applying information received from an investor (including information identifying assets to include in an investment entity portfolio) to the pre-defined parameters, guidelines or limitations. In this manner, the server(s) 20 or computer(s) 24 may be configured to determine whether or not the information received from an investor meets the pre-defined parameters, guidelines or limitations. The server(s) 20 or computer(s) 24 may be further configured to respond to the determination, by sending a pre-stored or generated notice to the investor of any noncompliance of the investor's asset information with the pre-defined parameters, guidelines or limitations.

If the asset and investment entity information received from an investor complies with pre-defined parameters, guidelines and limitations, then approvals from appropriate government, regulatory, industry or other relevant entities may be required or desired. For example, it is understood that the trading of securities in general is highly regulated, both at the Federal and State levels, and that such regulations impose varying requirements on trading, based on the type of security, the entities involved, and other criteria. In preferred embodiments, the parameters, guidelines and limitations are designed to meet (or, more preferably, exceed) the requirements for obtaining approvals from such government, regulatory, industry or other relevant entities.

At 106, or at any other suitable point in the process, any required regulatory approval is obtained. In general, a goal of the regulatory approval process is to obtain any required or desired authorizations for rapid creation of customized asset-backed securities. Preferably such authorizations are obtained in advance of receipt of a request from an investor to form an investment entity. For example, if the security as specified by the investor, i.e., the demanded security, requires registration with the Securities and Exchange Commission (SEC), the step of obtaining regulatory approval can entail applying for and preferably receiving advance approval with regard to issuing and/or trading the particular security. A process for providing expedited future issues of securities, such as shelf registration under SEC rule 415 may be employed, or other types of expedited registration processes wherein regulatory approval for creating securities in general according to this invention is obtained in advance, and with subsequent expedited approvals obtained for each of the particular securities created on demand.

Advance authorizations may be obtained, for example, based on pre-defined parameters, guidelines or limitations relating to the asset set to be included in an investment entity portfolio and/or other investment entity information (such as, but not limited to, the identity of the trustee, underwriter, distributor, ODF, exchange, combinations thereof or the like). Thus, based on a pre-established relationship with the approval entity, the ODF may define suitable parameters, guidelines or limitations that, if met by the investor's information and proposed asset set, would result in an automatic approval by the approval entity,as described above. Alternatively, upon meeting the pre-defined parameters,guidelines or limitations, an expedited or fast-track approval processing may be carried out by the approval entity.

At 108 details regarding creation and redemption of the security or shares of the investment entity are determined. This aspect may be accomplished in any suitable manner. In one embodiment, the details may be specified or defined by the ODF or, in certain circumstances, by the investor. In further embodiments, details regarding creation and redemption may be selected by the investor 14 from pre-defined details or sets of details that the ODF provides, where such pre-defined details may be designed to meet laws, regulations, policies or other specified criteria. In one example embodiment, the ODF may provide simplified procedures for an investor 14 to specify details regarding creation and redemption, for example, by providing prepared questions or prompts designed to obtain requisite information from the investor to define creation or redemption details. In network embodiments, such questions or prompts may be provided to the investor 14 over a network connection, for example, on an Internet website

For example, sale and redemption of shares in the security may be limited to large blocks of shares, in defined sizes known as creation and/or redemption units, in individual shares, or in blocks such as those customarily used in the trading of securities in exchanges such as the New York Stock Exchange. In a preferred embodiment, the entity creating the shares sells and redeems shares only in such creation and/or redemption units or blocks, while in the secondary market shares may be bought and sold individually. Accordingly, details specified by the ODF or the investor regarding creation and redemption may include, but are not limited to, specified creation unit size, redemption unit size, number of shares of the investment entity that corresponds to each creation or redemption unit, or the like. Such details may include cost imposte to create or redeem shares, due dates for which creation or redemption must occur, details regarding whether substitution is allowed for some or all of the portfolio, or the like.

Creation units may be purchased with cash, the specified assets, or in any other suitable manner. For example, to purchase a creation unit of an investment entity with a portfolio based on 50,000 shares of various automotive stocks according to investor's specification, the investor must supply 50,000 shares of the specified stocks in the appropriate proportions. Redemption may similarly be on any suitable terms, for example, the return of the 50,000 shares in the example investment entity in exchange for the securities used for the on demand securitization.

For example, an investment entity may have a portfolio I designed to track automobile sales industry and, thus, may including a certain number of shares of each of Automobile Company A, Automobile Company B, Automobile Company C, Automobile Company D and Automobile Company E. A creation unit in the investment entity may comprise a specified number of shares of each of those companies (for example, one share of each of Companies A-E, or a pro-rata number of shares of each Company based on the relative percentage of each Company's shares in the entire portfolio I). Similar rules may apply to redemption units.

Each creation unit represents a specified number of shares of the investment entity that holds the portfolio I. The number of shares of the investment entity per creation unit depends upon the percentage of the creation unit asset relative to the assets of the portfolio I and any other portfolios or assets held by the investment entity. Thus, an investment entity that holds a portfolio of one-hundered thousand (100,000) shares of each of Companies A-E, may have a defined creation unit of one hundred (100) shares of each of Companies A-E. If the investment entity held no other portfolios or assets, then the value of a creation unit would correspond to 100/100,000 or 1/1000 of the total shares of the investment entity. Thus, if the total shares of the investment entity (as defined by the investor, ODF or other entity as described above) is two million (2,000,000), then a creation unit in that investment entity may correspond to 1/1000 of 2,000,000 or 2000 shares of the investment entity.

At 110 the name and unique trading symbol for the investment entity, e.g., the ETF, fund, or trust, are determined or specified and the particular details regarding the investment portfolio of the entity are registered. At 112 the investment entity is formed, such as an ETF, that is based on the specification of the investor is created. Various types of entities, e.g., ETF, fund, or trust relationships are contemplated by the present invention. In one embodiment, a trust for holding the portfolio assets is created and a trustee is appointed. The trustee may be appointed in a variety of ways. For instance, the trustee may be selected from a list of pre-approved trustees provided by the ODF or specified by the investor.

In an example of an Internet or other network embodiment as described above, the ODF may provide a list or other arrangement of multiple trustees from which a choice may be made by or for the investor. The list or other arrangement of multiple trustees may be posted or otherwise provided on the ODF network site, for access by the investor. The list may include basis points, fees or other charges applied by each trustee, for comparison. Alternatively, or in addition, the ODF may provide a bulliten board or other location on a network site for allowing trustees to post information including rates and fees and/or for allowing investors or others (including the ODF itself) to post requests for proposals (RFPs) to solicit proposals from trustees. The ODF, through the ODF's website or otherwise, may provide a further procedure by which an investor may negotiate rates and fees with one or more trustees, for example, by email, postings, webconference or other bi-directional communication environment. In yet further embodiments, the ODF, through the website or otherwise, may similarly provide procedures for allowing an investor to conduct a form of an auction to solicit trustee bids, for example, whereby bids may be solicited on-line and posted for viewing by other potential trustee bidders. Thus, a network environment can expedite and make more efficient the process of appointing a trustee. The parameters, guidelines or limitations imposed by the ODF on the investor's choice of asset set or other investment entity information may vary, depending upon the particular trustee selected by or for the investor.

The appointed trustee generally manages the assets of the trust, which includes administering issuance and redemption of the creation units or shares, subject to approved rules, such as any applicable securities or commercial regulations. The creation of suitable entities and appointment of appropriate officials to oversee the entity fund, and/or trust will be well within the ordinary ability of those skilled in the relevant arts, once they have been acquainted with this disclosure.

Also, the forms and documents (paper or electronic) that may be required by a trustee for forming a trust for the proposed investment entity portfolio may be availale from the ODF. In a preferred embodiment, through a pre-established relationship with one or more (preferably multiple) trustees, such forms and documents are completed as far as possible by the ODF, in advance of the investor's request for forming an investment entity. In this manner, only portions of the forms and documents needed to identify the particular asset set and/or other specific information need be added to the forms or documents, upon receipt by the ODF of an investor's request to form an investment entity.

Trustee forms and documents for at least one (preferably multiple) trustee entity may be stored in a partially completed format in the ODF database 22. In an Internet embodiment as described above, such forms and documents may be made available to investors for review or completion, for example, through a posting or other location on the ODF's network site.

At 114 the securities created on demand are listed on an exchange by an exchange entity which provides for periodic reporting of the value of the securities in the portfolio, e.g., daily. An ODF also may communicate listing information and/or provide a link on the ODF's network site to a network site or page operated by the listing exchange or other entity authorized for publishing or otherwise posting such listing information.

In a preferred embodiment, parameters, guidelines or limitations imposed by the ODF on the investor's choice of asset set or other investment entity information may vary, depending upon the particular exchange or exchanges on which the investment entity security is to be listed. In this manner, the ODF may define suitable parameters, guidelines or limitations that meet or exceed the requirements of the exchange(s). Different parameters, guidelines or limitations may be applied for different exchanges. Such parameters, guidelines or limitations may be determined in advance of the ODF's receipt of a request from an investor, through a pre-established arrangement between the ODF and one or more exchanges.

Thus, as described above, embodiments of the present invention involve at least one investor/ODF combination. The investor is any entity or individual that may submit a demand for the creation of securities, e.g., the creation of shares of an investment entity (ETF, fund, or trust,) as described herein. As noted above, the investor may, for example, be an institutional investor, an individual investor, hedger or other market-interested party. An ODF is any entity that may generally create the securities on demand and has the ability to list or cause to be listed the created security either directly or indirectly through an exchange.

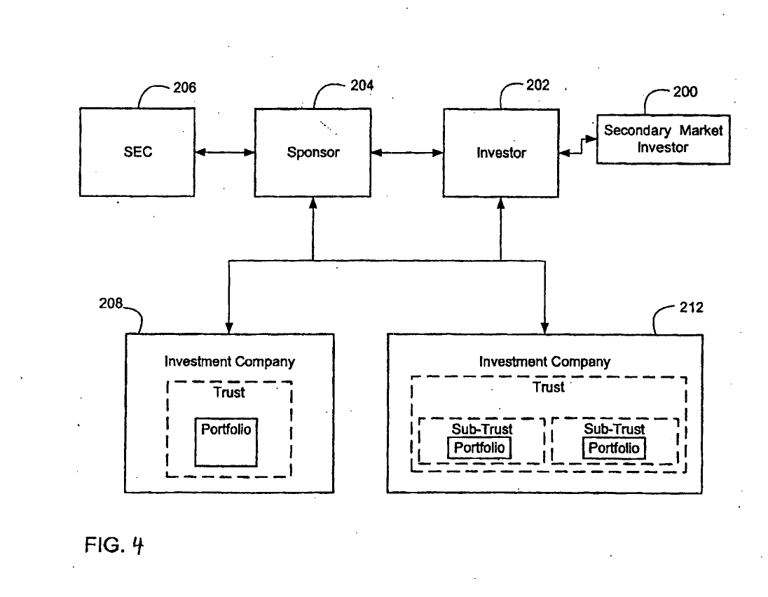

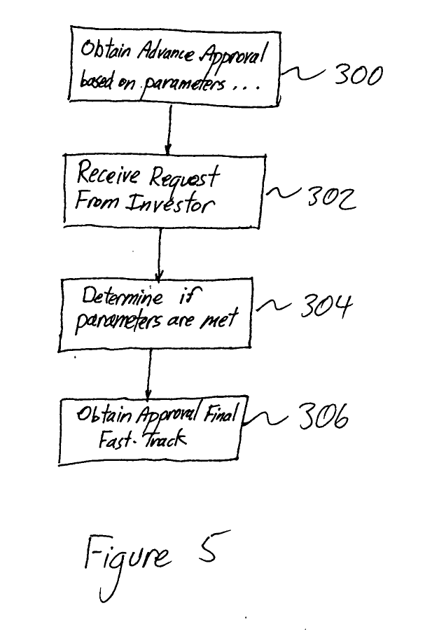

Referring to FIG. 4, investor 202 generally provides asset information to ODF 204. In one embodiment, the ODF coordinates regulatory approval with the SEC or other regulatory agency(ies) 206. Alternatively, the investor, the trustee, or any other suitable entity may coordinate any required regulatory approval.

In FIG. 4, ODF 204 creates the investment entity, e.g., ETF, fund, and/or trust, according to the investor's specification and in accordance with any applicable laws and/or regulations. Various ETF, fund, and/or trust combinations may be created in furtherance of the present invention, two examples of which are represented at 208 and 212.

one example embodiment, a single investment entity 208 is created that holds a single portfolio defined by investor 202. For example, a single ETF may be created wherein a trust is created to hold the portfolio assets and issue securities.

In another embodiment, a single investment entity 212 is created to securitize a plurality of portfolios as defined by one or more investors. For example, a single trust may be created to control a plurality of sub-trusts, each created on demand to hold and securitize a single portfolio. The sub-trust then creates an investment entity, such as an ETF, whose shares represent investment in the particular sub-trust portfolio created on demand. This particular aspect of the present invention, may further facilitate expedited regulatory approval wherein regulatory approval for the investment entity or trust is obtained at the onset and subsequent approvals for each of the sub-trust portfolios created on demand obtained on an expedited basis or in accordance with an expedited procedure.

The flow-chart of FIG. 5 represents an example embodiment involving pre-approvals, fast-track processing or other forms of expedited processing based on pre-established arrangements, pre-defined parameters, guidelines and limitations. In FIG. 5, at 300, an ODF 12 obtains pre-approvals and/or establishes expedited approval arrangements with one or more government, regulatory, industry entity or other approval entity, exchanges, trustees, underwriters, distributers or the like, for forming investment entities. The pre-approval or expedited approval arrangements may be based on parameters, guidelines and/or limitations that must be met by the proposed investment entity (e.g., the asset set of the investment entity portfolio), as described above. Thus, for example, the ODF and the approval entity may agree that any asset set that meets certain defined parameters, guidelines or limitations will (or is likely to) be approved by the approval entity.

Once pre-approvals are in place, the ODF may then receive 302 a request or requests for creating an investment entity, such as a custom ETF, on demand from one or more investors. The request may include the specification for the on demand ETF, including information regarding indexation (the mix of securities to be included in the portfolio), creation/redemption, quantity or quantities, the trustee, etc. The information included in the request may be evaluated at 304 to determine if it meets the parameters, guidelines and limitations. A unique name and symbol may be created (and optionally trademarked) for each on demand ETF, as described above. At 306, fast track regulator approval for the ETF is obtained for the investment entity security that meets the pre-defined parameters, guidelines and limitations, and the ODF lists the ETF security on an exchange. The ETF is then ready to create and/or issue creation units or shares and redeem creation units or shares accordingly.

By providing an expedited procedure for on-demand securitization, embodiments of the invention may be employed in a variety of contexts. For example, a portfolio or fund manager may need to aquire or liquidate a number of assets for a portfolio or find. By contacting an ODF 12, the portfolio or fund manager may define an investment entity asset set as corresponding to the assets that the portfolio or fund manager intends to acquire or liquidate. The manager may work with the ODF to create an investment entity based on an index which converts the portfolio into tradeable share units. The creation and public offering of securities in the investment entity (where the investment entity portfolio is composed of the asset set), the portfolio or fund manager may be able to meet the “best execution” requirements for the acquisition or liquidation of the asset set. According to another example embodiment, a bankruptcy trustee or a probate trustee may contact an ODF to form an investment entity for purposes of liquidating trust assets, whereby the asset set of the investment entity is defined by or includes the assets in bankruptcy or probate. In yet another example embodiment, a portfolio manager specializes in buying stocks in a ceratin industry, for example, gaming stocks, and desires to create a market capitalized index of gaming stocks.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

1. A method for on-demand securitization, comprising:
receiving information regarding a proposed investment entity to be created, including information regarding an asset set to be included in a portfolio of the proposed investment entity;
defining parameters, guidelines or limitations regarding asset sets that may be included in portfolios of investment entities, wherein the parameters, guidelines or limitations are based on requirements for obtaining regulatory approval;
determining that the asset set to be included in a portfolio of the proposed investment entity meets the defined parameters, guidelines or limitations;
obtaining regulatory approval to create a customized security for the proposed investment entity backed by the asset set in the portfolio; and
forming an investment entity for holding the asset set.

2. A method as recited in claim 1, wherein obtaining regulatory approval comprises obtaining pre-approval to create a customized security for an investment entity backed by an asset set that meets the defined parameters, guidelines or limitations, in advance of receiving information regarding a proposed investment entity to be created.

3. A method as recited in claim 1, wherein obtaining regulatory approval comprises obtaining a shelf approval, fast track or other expedited approval processing from the Securities and Exchange Commission to create a customized security.

4. A method as recited in claim 1, wherein receiving information comprises providing network site for access by investors and receiving information over the network from an investor during a communication session with the investor accessing the network site.

5. A method as recited in claim 4, wherein the network site comprises an Internet website.

6. A method as recited in claim 1, wherein receiving information comprises providing an Internet website for access by investors, the website including at least one location for an investor to enter information regarding a proposed investment entity.

7. A method as recited in claim 6, wherein the at least one location of the website comprises input fields marked with indicia indicating the type of information to be entered into the input fields.

8. A method as recited in claim 1, wherein forming an investment entity comprises forming a trust for holding the asset set.

9. A method as recited in claim 8, wherein forming a trust comprises partially completng trust documents for a proposed investment entity in advance of receiving information regarding a proposed investment entity to be created, and completing the trust documents with received information.

10. A method as recited in claim 9, wherein receiving information comprises providing a network site for access by investors, the network site including at least one location for an investor to enter information regarding a proposed investment entity.

11. A method as recited in claim 10, wherein the network site comprises an Internet website.

12. A method as recited in claim 1, wherein determining that the asset set meets pre-defined parameters, guidelines or limitations comprises configuring a computer to compare the asset set information with information associated with the pre-defined parameters, guidelines or limitations.

13. A method as recited in claim 1, wherein the asset set comprises an ETF.

14. A method as recited in claim 1, wherein information regarding the proposed investment entity further includes at least one of information regarding the size of creation and/or redemption units, a total quantity of shares to be created, an identity of a trustee to manage the investment entity and timing requirements for the securitization.

15. A method for on-demand securitization, comprising:
receiving information from a third party regarding a proposed investment entity to be created, including information regarding an asset set to be included in a portfolio of the proposed investment entity;
determining that the asset set to be included in a portfolio of the proposed investment entity meets pre-defined parameters, guidelines or limitations;
forming an investment entity for holding the asset set;
causing securities in the investment entity to be listed on an exchange.

16. A method as recited in claim 15, wherein the parameters, guidelines or limitations are based on requirements for obtaining regulatory approval and wherein the method further comprises obtaining regulatory approval to create a customized security for the proposed investment entity.

17. A method as recited in claim 15, wherein receiving information comprises providing a network site for access by investors and receiving information over the network site from an investor during a communication session with the investor accessing the network site.

18. A method as recited in claim 17, wherein the network site comprises an Internet website.

19. A method as recited in claim 15, wherein receiving information comprises providing a network site for access by investors, the network site including at least one location for an investor to enter information regarding a proposed investment entity.

20. A method as recited in claim 19, wherein the network site comprises an Internet website.

21. A method as recited in claim 19, wherein the at least one location of the network site comprises input fields marked with indicia indicating the type of information to be entered into the input fields.

22. A method as recited in claim 15, wherein forming an investment entity comprises forming a trust for holding the asset set.

23. A method as recited in claim 15, wherein information regarding the proposed investment entity further includes at least one of information regarding the size of creation and/or redemption units, a total quantity of shares to be created, an identity of a trustee to manage the investment entity, and timing requirements for the securitization.
